(19) United States
(12) Patent Application Publication
(10) Pub. No.: US 2018/0063857 A1
(43) Pub. Date: Mar. 1, 2018

(54) ENHANCED PARENTAL CONTROLS FOR GATEWAY

(71) Applicant: Intel Corporation, Santa Clara, CA (US)

(72) Inventor: Adam D. Caplan, Folsom, CA (US)

(21) Appl. No.: 15/252,817

(22) Filed: Aug. 31, 2016

(51) Int. Cl. H04W 72/12; H04W 28/02

(52) U.S. Cl. CPC H04W 72/121; H04L 67/303; H04W 28/0215

(57) ABSTRACT

A gateway device or component of a gateway device operates to control one or more user devices communicatively coupled to the gateway device via a home wireless network. A control component generates a user interface with a master profile comprising one or more user device controls configured to control media content streaming to the plurality of user devices based on an award process and a set time range. An award component generates the award process by determining whether a merit or a demerit corresponding to at least one user device of the plurality of user devices is received, adding time to the set time range corresponding to the plurality of user devices in response to the merit being received, and removing the time from the set time range corresponding to the plurality of user devices in response to the demerit being received.

### FIELD

The present disclosure is in the field of parental controls, and more specifically, pertains to parental controls for a gateway device.

### BACKGROUND

Parents' ability to limit their children's time on the internet is increasingly difficult. With multiple devices providing access points (phones, tablets, televisions, computers, consoles) and each having different settings and controls, parents have a harder time keeping up. Simply blocking a devices access to the internet is often not a good option because the device connects to a wireless router to download updates, and perform other routine tasks. In order to manage all of this activity, it could go a long way to help parents take back control of their kids' connected screen lives.

### BRIEF DESCRIPTION OF THE DRAWINGS

FIG. 1 is a block diagram illustrating a gateway system or device according to various aspects described.

FIG. 2 is another block diagram illustrating a control component of a gateway device according to various aspects described.

FIG. 3 is another block diagram illustrating a gateway system or device according to various aspects described.

FIG. 4 is a block diagram of a process flow for a gateway device according to various aspects described.

FIG. 5 is a block diagram of a user interface for a master profile in accordance with various aspects described.

FIG. 6 is a block diagram of another user interface for an award process in accordance with various aspects described.

FIG. 7 is a block diagram of another process flow for a gateway device according to various aspects described.

FIG. 8 is an exemplary wireless terminal, gateway device or user device for implementing various aspects described.

### DETAILED DESCRIPTION

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor, a process running on a processor, a controller, an object, an executable, a program, a storage device, and/or a computer with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising”.

### Overview

In consideration of the above described deficiencies of parental controls, a home gateway device for a home wireless network is disclosed that enables flexible and dynamic interfacing with various networked devices (e.g., a tablet, smartphone, notebook, mobile phone or other wireless device) that are communicatively coupled to a home wireless network. An interface (e.g., a user interface) can be generated by a control component of a gateway device that enables one or more user profiles corresponding to a user or a user device as part of the networked devices. The user profiles can include a master profile that is generated to enable control of the various devices either directly or via user profiles corresponding to different users for particular user devices. The control component can manage control of these user devices based on an award process and a time range or viewing schedule.

An award component, for example, can operate to enable incrementing and decrementing time with a set time range according to an award process. When a user of a device completes an application (e.g., a task via the user device, with a component of the network (user) device, by manual entry from the master profile or the user profile, or otherwise), then additional time for using or viewing media content streamed to the user device for the set time range within a given period can be incremented or awarded.

As one or more of the user devices, either coupled via a particular user profile to the control component or the master profile, uses up viewing/operation time from the set time frame within a period, time can be decremented. At the end of the allotted set time range, media content can be blocked from being streamed to the user devices under the user profile for control of a specific device, directly to a specific device or groups of user devices sharing the set time frame or allotted duration for operation. Alternatively or additionally, the one or more user devices being governed by the set time range can be configured to power off via the interface so that all operational use is blocked or ceased. Additional aspects, embodiments or details of the disclosure are further described below with reference to figures.

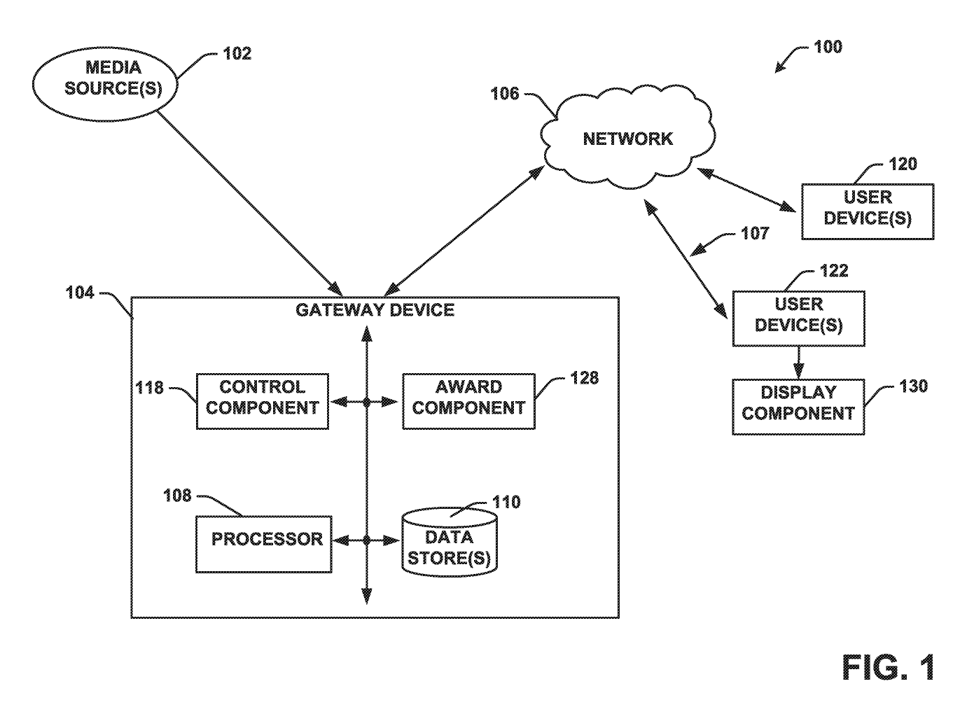

FIG. 1 illustrates an example gateway system 100 with a gateway device 104 configured to control one or more groups of user devices in a wireless network based on an award process, a set time range, or one or more user profiles in accordance with various embodiments or aspects. System 100 can include a memory or data store(s) 110 that stores computer executable components and a processor 108 that executes computer executable components stored by the processor 108 or data store(s) 110, examples of which can also be found with reference to other figures disclosed herein.

The system 100 comprises a gateway device 104 that can further include a router, a firewall, server, or other network device that enables traffic to flow in and out of the network, such as a home network 106 with one or more media sources distributing content on an internet, intranet or other network. The gateway device 104 can operate to enable or manage this traffic to one or more user devices 120 and 122 that are communicatively coupled to the network 106, which can be generated by the gateway device 104 or other home network device, for example. A user device of the user devices 120 or 122 can include a mobile device, a smart phone, a laptop, a personal digital assistant, a personal computer, a television, a mobile phone, a hand held device, a digital assistant, game console, or other similar processing device, which can include hardware/firmware/software communicating via the network 106, other network, or a wireless/wired transmission.

The gateway device 104 can further comprise a control component 118 and an award component 128 that can operate to obtain media content (e.g., video content, audio content, subscription content, application content, etc.) from various media sources 102 via the processor 108 and data store(s) 110 and dynamically communicate the media content in response to user profile data, a master user profile, the award process or related parameters of the award process (e.g., a time frame, a schedule, a viewing range, times, a given period, increment/decrement award amounts, a shared time pool among one set of devices 120 or another set 122, or other operations). The gateway device 104 can operate with the control component 118 to control content of media sources 102 or media source streaming to the user device(s) 120 or 122, such as by address, user profile data, a subscription service, a network affiliation (e.g., network subscription, social network profile, blog feed, etc.), and corresponding content (e.g., news broadcast, television programming, web cast, web page feeds, personal data and other media content) to be rendered via a display component 130 of one or more sets (groups) of user devices 120-122.

The gateway device 104 can also operate via a wireless network 106 based on one or more user profiles associated with the user device(s) 120-122. Various video content or media content sources 102 can be identified via the control component 118 while utilizing one user profile (user profile data) to control a first set of device(s) 120 and another user profile for a second set of device(s) 122.

The control component 118 can operate to generate a master user profile that controls each set of user devices 120, 122 independently. The controls can affect each user device or set of user devices 120, 122 directly at each device by enabling user device controls for establishing limits or restraints on viewing/operational time via one or more parameters of the award process. In addition or alternatively, these user device controls can affect each user device coupled to the network 106 by setting parameters on a user profile so that different users can be restricted independent of the device, and control can be based on the user signing into use a user device, or a group of user devices 120 or 122.

Alternatively or additionally, user device controls enabled by the control component 118 can affect each user device, or sets of user devices 120, 122 via the control component 118. For example, the control component 118 can control user devices 120 or 122 by blocking or directing video content from a network address, receiving subscribed feed data, accessing user profiles through the profile data dynamically, local channel subscriptions, other video content subscriptions, web sites/portals, personalized video libraries, wireless broadcast video content reception, cable streaming, other user device data operation, or the like. In addition, media content from media sources 102 streaming through the gateway device 108 via the network 106 to the user devices can be restricted so that media content is cut off after a certain time range has been reached by a particular user device or by the set of user devices 120 or 122 overall, either independently or in aggregate.

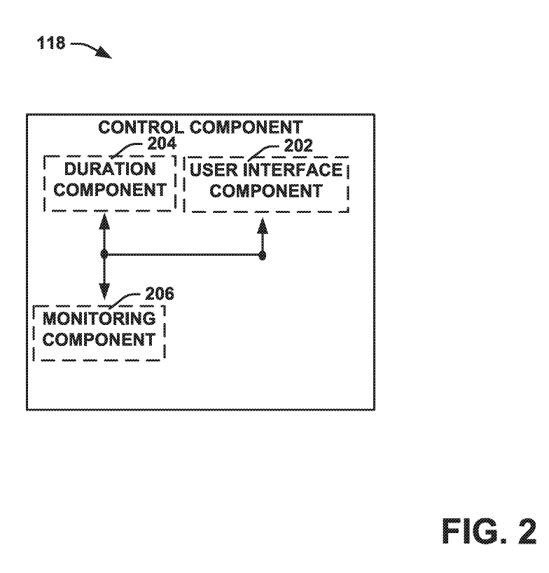

The time range or other parameters that can be controlled through a user interface that can be generated by the control component 118 (e.g., via a user interface component 202 of FIG. 2), such as via a duration component (e.g., duration component 204 of FIG. 2) and can be shared among user devices 120, 122, by a particular user profile associated with the user devices 120, 122, or by control of the power/power settings for a particular device directly. This user interface can also provide the master profile for control over each device or user profile associated with the user devices 120, 122, for example, such as for a parent with respect to a particular one or a group of user devices 120 or 122.

In addition or in alternative to restricting the streaming of one or more kinds of media content (e.g., video content, music content, or particular media content sources), the control component 118 can also respond to a master profile setting to provide limits on operational streaming or powering of particular user devices 120/122 and govern particular sets/groups of devices 120/122 independently and separately from one another. In this manner, user devices 120 can share a corresponding set time frame or duration associated with one group over another group of user devices 122. For example, the master profile can provide set times to the streaming/powering of each user device, set of user device(s) 120 or to different sets of user device(s) 120, 122 for each user.

User device controls or settings generated by the control component 118 can therefore, as with a restricted time range, set time frame/duration, or power for media content streaming, could be assigned to a particular user profile to govern more than one user device 120, or operate via the settings of a set of user devices 120 associated with a particular user that is known to own or operate such user devices 120, for example. Consequently, one set of user devices 120 or user profile can have restrictions or parameters that govern differently and independently from another set of user devices 122 for a different user (e.g., a dependent or child).

The control component 118 can further be configured to generate a set of viewing controls as part of user device controls associated with the user profile data that control transmission of the media content. The set of viewing controls generated by the control component 118 can comprise a timed duration control to define a timed duration for receiving/transmitting media content. These controls can operate to block, restrict or determine which user devices 120 or 122 receive what kind of media content (e.g., video, audio, text, etc.), the amount of use for each device or the set of user devices 120, the set time range, a time frame, a schedule, period of time, periodicity for each setting to expire, or other parameters.

The control component 118 can have a monitoring control (e.g., via monitoring component 206 of FIG. 2) to monitor or record a viewing of the media content to one or more user devices 120 or 122. Additionally, the control component 118 can generate an authentication control for employing user authorization and authentication based on the user profile data a user profile that corresponds to another client or user, and/or an additional client viewing devices (e.g., a child's viewing or child's viewing device).

In one example, the master profile can control the set of user viewing controls via the control component 118 from a first mobile or user device 120 to set a timed duration or other controls associated with receiving the media content at a second user device 122, or at the same device with display component 130 for example. A parent or authority/owner associated with the master user profile to control particular user profile data of a user device 120 or 122 can operate the control component 118 to implement a setting as a user device control, which can control a maximum time (or set time frame) for a given period that operates or allows media content streaming for the user (e.g., child, subscriber or other) via the user device 120. In response to the time interval (timed duration) expiring, the control component 118 can operate to switch the user device(s) 120 or 122 to a powered off mode, in which no operation is enabled.

The control component 118 can also operate to set authorization or authentication controls that are associated with a user profile of a set of user devices or with the user devices 120 via device settings (e.g., login data, a secure phrase, pin number, challenged response, inherence factor—biometric print, retinal scan, etc., or a two factor authentication). For example, a parent corresponding to the master user profile could enter a pin code or password along with the required time interval for setting a timed duration of viewing or streaming of media content associated with one or more other user/user device(s) 122. The parent could also be enabled to cancel the time interval by accessing the setting/controls via entering or enacting the same security (e.g., pin code) or other security protocol comprising a one or more combinations of the user profile data and security examples above.

In addition, other controls of the control component 118 can be activated or set. For example, a user of the system 100 can avoid some particular content (associated with a parental rating, a time period in a day, genre, or from other classification criteria) for being viewed. The controls can become available for parents or a user with a user-generated pin code, for example. When this option becomes active, all such content (or any content in a particular time period) can require the pin code in order to be watched via the gateway device 104, which can operate as a home router, WiFi, internet provider, or other home gateway device, for example.

Parents, being away from the display component 106 or viewing user device 120, 122, could also enter their user profile data to access the master user profile remotely and see what media content is being streamed, review a duration of viewing for one or a set of user devices 120, set a maximum, set a particular schedule, set a time period by increment or decrement, review a type of media content, block content, set power or operational times, review a media subscription feeds, or other operational use of a particular one or set of user devices 120. The user profiles related to each user device or set of user devices 120 or 122 can be modified according to these parameters or settings via the master user profile, or the user device or set of user devices can be controlled directly via the control component 118. Additionally or alternatively, the control component 104 can be forced to stop, playback, enter powered off mode, or block streaming content, in which no media content is communicated via the wireless network 106, or control power enabled for the user device or set of user devices 120 or 122, for example, based on such user device controls of the master user profile.

The award component 128 can be communicatively coupled to the control component 118, and can operate to generate the award process by determining whether a merit or a demerit corresponding to at least one user device, the set of user devices 120, 122, or user profiles corresponding thereto has been received. In response to the determination, the award component 128 can increment/decrement time for a given period of user device operation accordingly as part of the award process.

In one example, an application of the user devices 120 or 122 can indicate whether one or more tasks have been achieved or completed, and communicate these accomplishments as they are unlocked or completed to the award component 128 of the gateway device 104. An application can be educational, instructional, entertaining or any set of tasks generated and provided by one or more user devices 120, 122 for a user of a particular user profile, provided by the processor 108 via the gateway device 104, or stored on a the network (as a cloud storage) or other storage device 106. The application can refer to a task being achieved or a set of processes for communicating that such task is being performed, has been performed, or is not yet performed but assigned to a user or the user devices 120, or 122, for example. The completion of a task can be communicated via the user device 120 or 122 or entered manually via the master user profile where the task is not associated with any user device. The master user profile can thus record the increment or decrement entered via the control component 118, and communicates the entry to the award component 128 to process as part of the award process by increasing an amount of time for operation/data streaming via the user devices 120 or 122.

In addition, the user device 120 or 122 can be rewarded with additional time range for operating a user device or streaming media content by an increment of time that can be set by the user device controls to the maximum set time frame over a given period, which can be replenished for each additional period. This can result from non-use of the user device 120 or 122 within certain times, over a certain period of time, or use being held within a certain time range for a given period, during certain times (not during dinner) or other such parameters, for example, in order to award the user. In this manner, a user can be rewarded automatically for adhering to a schedule or set time frame of use.

Likewise, in response to the time range or time frame being exceeded, a set time frame threshold being satisfied via the use of one or more sets of user devices 120, or a schedule of use not being adhered to, for example, the streaming of all media content could be blocked for a given period until a new set time frame is enabled based on a periodicity, set cycle of time or an override provided via a user device control of the master user profile. Accordingly, the award component 128 can thus add time to the set time range corresponding to the set of user devices 120, or any particular user device separately, in response to a merit being received, and can also remove time from the set time range corresponding to the set of user devices 120 in response to a demerit being earned or received. Such a demerit can be set according to an amount of decrement, based on one or more applications or task not being received as unlocked or achieved, exceeding a set time frame of use for the set of user devices 120, or other purposes that can be received as an indication of demerit to the award component 128.

Referring to FIG. 2, illustrated an example another example of an example gateway system 100 with the gateway device 104 configured to control one or more groups of user devices 120, 122 in a wireless network based on an award process, a set time range, or one or more user profiles in accordance with various embodiments disclosed. The control component 118 can include a user interface component 202, a duration component 204, and a monitoring component 208.

The user interface component 202 can be configured to interact with a user device 120 or 122 by an interactive interface that generates one or more settings for controlling user preferences or controls via a master profile or other user profiles associated with a user and a user device or set of user devices 120, 122. The user interface component 202 could also implement each setting and generate a notification of a set time frame/timed duration for operation of one or more user devices among the sets of user devices 120, 122, or for each set of user devices independently from one another. The user interface component 202 can provide one or more user programmed settings with an interactive control for viewing or operational times of media content streaming that are authorized through the master profile.

In one example, the user interface component 202 can be configured to provide an indication that the timed duration is at an ending time for viewing the media content 102. Therefore, if the timed duration is set for three hours each day, under a child's profile data, then a particular user device, a shared set of user devices 120 or 122, or a user profile can generate an indication of the time duration for the given period (a day) as well as any time remaining at any interval or period, along with any awarded time incremented or time decremented after use or manual modification of the setting. Subsequently, the control component 206 can operate to block any further viewing content and enter in stand-by mode, sleep mode, power off mode, or some other viewing mode to prevent the user device, the user or the streaming of media content for the user profile account, the particular device, or set of user devices 120 or 122.

In another embodiment, the duration component 204 can be configured to generate the user device controls for the master profile to view, adjust, or set for controls of the user devices 120 or 122. For example, a duration control can be generated and communicated via the user interface component 202 that corresponds to the media content that streams via the gateway device 104, or a period of operation for the set of user devices 120 or 122. Different durations or a single duration of time (or set time frames) could be assigned to a same user device, but for a different user (e.g., a child), time, period, or schedule. Multiple users can then utilize the one device based on their profile, such as a family television, for example, or family smart phone, or a set of user devices 120, for example. A set of user devices 120 can also subscribe to the same media content as configured and controlled by the primary user via the master profile.

In another embodiment, the monitoring component 208 can be configured to enable a user device, such as user device 120 to access the media content at a same time as a second user device 122 to review progress or what is being streamed. The monitoring component 208 can further be configured to communicate the media content to the first user device 120 and the second user device 122 so that two devices can view the same content simultaneously. Further, the monitoring component 208 can also operate to record media content or metadata related to media content being viewed by the first user device(s) 120 for further review by the second user device(s) 122.

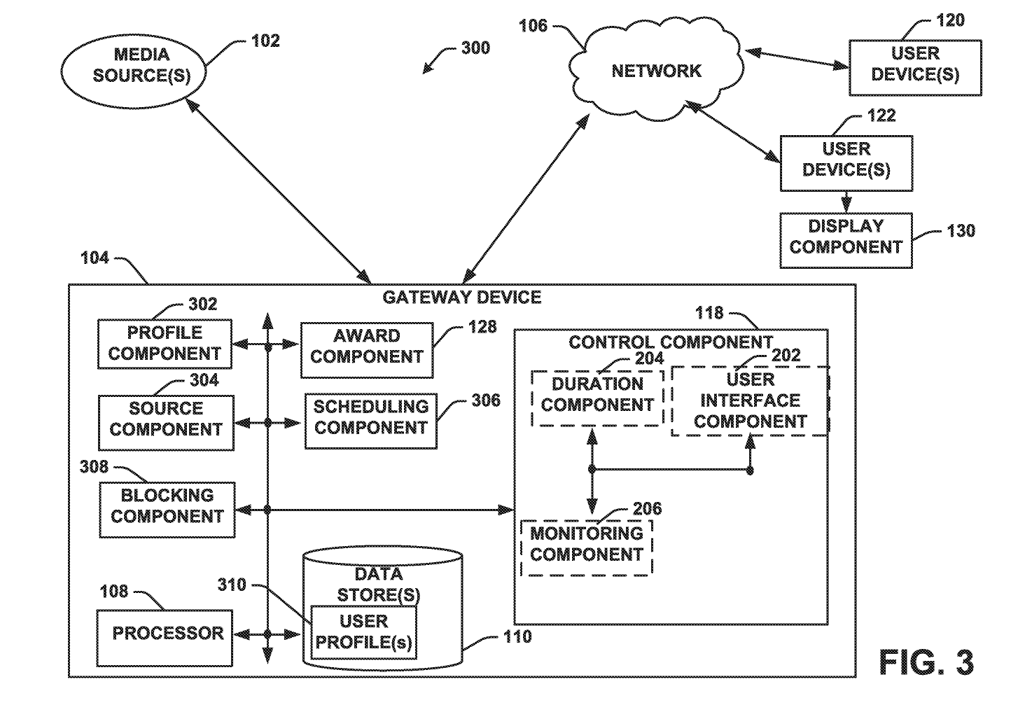

Referring to FIG. 3, illustrated is another example of a gateway system 100 with the gateway device 104 configured to control one or more sets of user devices 120, 122 in a wireless network based on an award process, a set time range, or one or more user profiles in accordance with various embodiments or aspects. Similar to FIG. 1, the gateway device 104 further includes a profile component 302, a source component 304, a scheduling component 308 and a blocking component 308.

The profile component 302 can generate one or more user profiles 310 associated with a user and a master profile that can be secured for control via another user (e.g., a parent). The user profiles can be assigned via the profile component to individual users along with user device controls and related parameters with one or more user device(s) 120 or 122. The user profiles can enable a same user device or set of user devices 120 to be used by the same person at different times under different profiles. In addition or alternatively, the user profiles can be assigned a same user device to enable use by two different users at the same time.

A user profile 310, for example, can also include user profile data with user preferences related to the media content. The user profile data can include login information, a user name, user personal data, authentication data, media source preferences, media content preferences, time preferences for video content/media sources, date preferences for video content/media sources or the like user preferences for a particular user (e.g., a child). The user preferences can further include a time preference to associate with the media content or video content and other classification criteria, such as types of media content (e.g., Science Fiction, Drama, etc.), a rating preference (e.g., G rated films, five star films, etc.), a language preference (e.g., Spanish, Russian, English, etc.), or other preferences that can be controlled by the master profile or a corresponding user profile together, or independently for enabling media streaming. The user profile data configured by the profiling component can further include metadata related to a history of the media content streamed to the user devices 120.

Various video content sources can be identified via the source component 114 and filtered by utilizing a user profile or a master user profile associated with the user devices 120 or 122. The source component 304 can serve to identify metadata in order to allow or filter certain types of media content, subscriptions, media sources 102, ratings or other related data and communicate the media sources to user profile settings or the blocking component 308, for example, for blocking or other restriction.

The streaming component 120 is configured to communicate the video content from the plurality of media sources 102 to the display component 106 (e.g., a display panel, a display device—mobile smart device, personal gateway device, personal digital assistance, mobile device, processor device, etc.) based on the demographic data and user profile data generated by the gateway device 104. The streaming component 120 is further configured to communicate the video content from different media sources of a plurality of media sources at different times based on the user profile. Further, the streaming component 204 can operate to communicate different video content from different media sources at the same time at different personalized channels 107, and/or at the same channel for interacting with one type of content and viewing another, such as video chat with various user devices while viewing the video content from media sources at the same time.

In another embodiment, the gateway device 104 can operate to stream video content via the scheduling component 306 from various media sources at prescheduled timing, and based on the user controls of the control component 118 as well as the user profile data with video content of media sources. The media sources 102 can comprise at least two of a broadcast (wired/wireless), power line carrier signal, optical link, web feed, web link, a network, personal video library or the like. The user profile or master user profile overriding the user profile, or alone, can set the content, times and media sources with user preferences and control the communication of the content to user devices 120, 122. The gateway device 104 can operate to recommend or suggest configurations (video content, scheduling, media source options) as selectable user viewing options based on the user preferences and/or behavioral data about the user that is learned from the system as part of the user profile data. Additionally, other criteria or classifications can be programmed along with video content and various media sources in particular for different time slots based on the user's interest or restriction.

The scheduling component 306 can further generate a set schedule of media content via a user profile associated with the user device(s) 120. The settings can include the set time range, a set time, a time period associated with the set time range, a powering on or operational timed limit, a media content source or a related periodicity by which an allotted time can be replenished or an application/task should be completed, for example. The schedule or related schedule settings for a particular user device or set of user devices can be set, modified or prioritized over any user profile corresponding to a user device via the scheduling component 306. Alternatively, no user profile could be assigned to any user device and a master user profile could serve as a general user profile for all user devices and grouping user devices according to independent parameters, settings or other variables disclosed herein.

The blocking component 308 can be configured to block at least a part of the media content from the media sources 102 to or from the set of user devices 120, 120 based on the user device controls of the control component 118, the schedule settings of the scheduling component 306, the award component 128 or other components. For example, the blocking component can block transmission from the user devices 120 or 122 outside of the home network 106, or media content from one or more websites, either independently or collectively via internet access. The settings for blocking content or use can include, for example, at least one a media source, a timed duration, a rating, a time, a date, a genre or other related media content or operational power parameter/setting.

For example, the blocking component 308 can enable media content to stream only cartoons and to block other content/media sources 102 that could be identified from other sources, such as adult rated content, or other content that is not suitable for a child according to an indication via the master profile. In another example, a personalized video library having personalized video content as identified by the source component 304 could be blocked from being published.

Some of the time slots for the schedule of use or viewing via one or more user devices, for example, could be left open for selection of the time of viewing via the scheduling component 306, and thus, not be pre-scheduled, while other time slots are scheduled. Therefore, video content/media sources can be blocked by the blocking component 308 for the specified time slots. For example, mornings could have various video content blocked for children with some freedom of selection from among media content and media sources, but on a limited basis so that adult rated content is not able to be accessed or some other classification of video such as by title, genre, language, rating, etc. is blocked from access, for example.

The blocking component 308 can block the at one user device while allowing access of another, or one set of user devices 120 over another 122. Each user device or set of user devices can be blocked based on the user device controls of the master profile, which an include the set time range, a time period, a rating of the media content streaming, a type of media content, as well as a user device designation to one or more parameter/settings or to a particular set of user devices 120, for example, and can also be assigned to or based on a number of merits and demerits as part of the award process.

In another embodiment, the blocking component 308 can serve to block streaming or powering of the user devices in response to a set time frame, duration, or accumulation of an amount of user device time from among the set of user devices sharing the settings. As such, once a threshold set by a setting has been exceeded or satisfied, the content or powering of the user device can be blocked or initiate powering down processes via the device itself or a corresponding user profile setting.

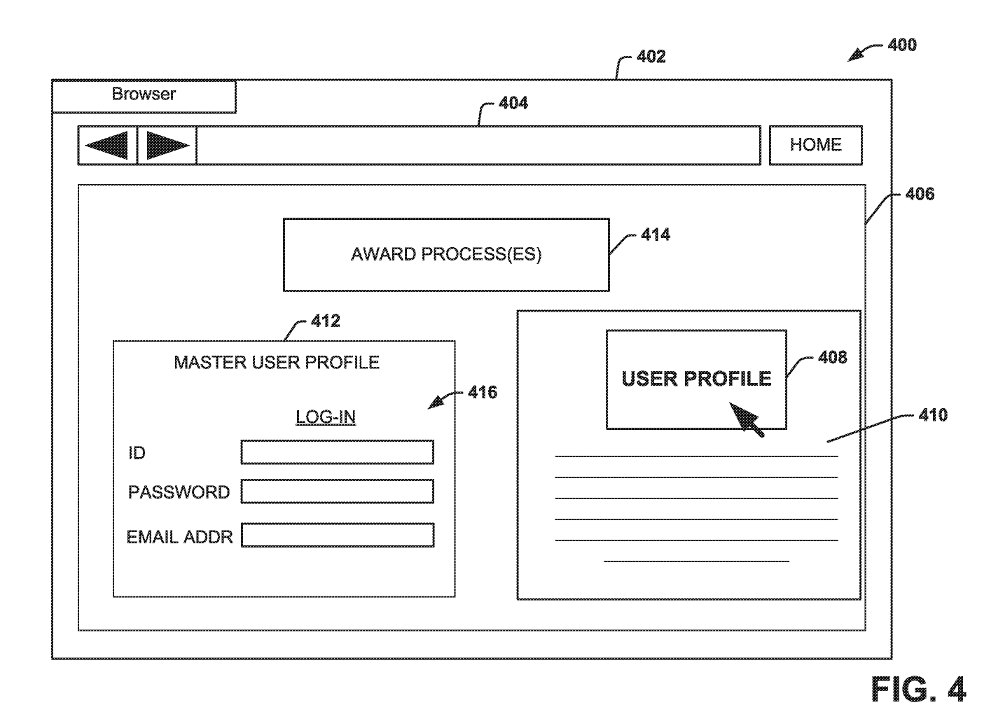

Referring to FIG. 4, illustrated is an example user interface 400 that can be generated by the user interface component 202. The user interface can be rendered in the display component 130 of a user device 122 of FIG. 2, for example. A browser 402 of the user device 122 can render a viewing pane 406, which can have an address bar 404 or other addressing mechanism. The browser 402 can expose initiation mechanisms such as an interface control 408 to initiate or facilitate a communication of a user profile 410 associated with a particular user or a particular device 120, a master user profile 412 and an award process interface control 414, for example.

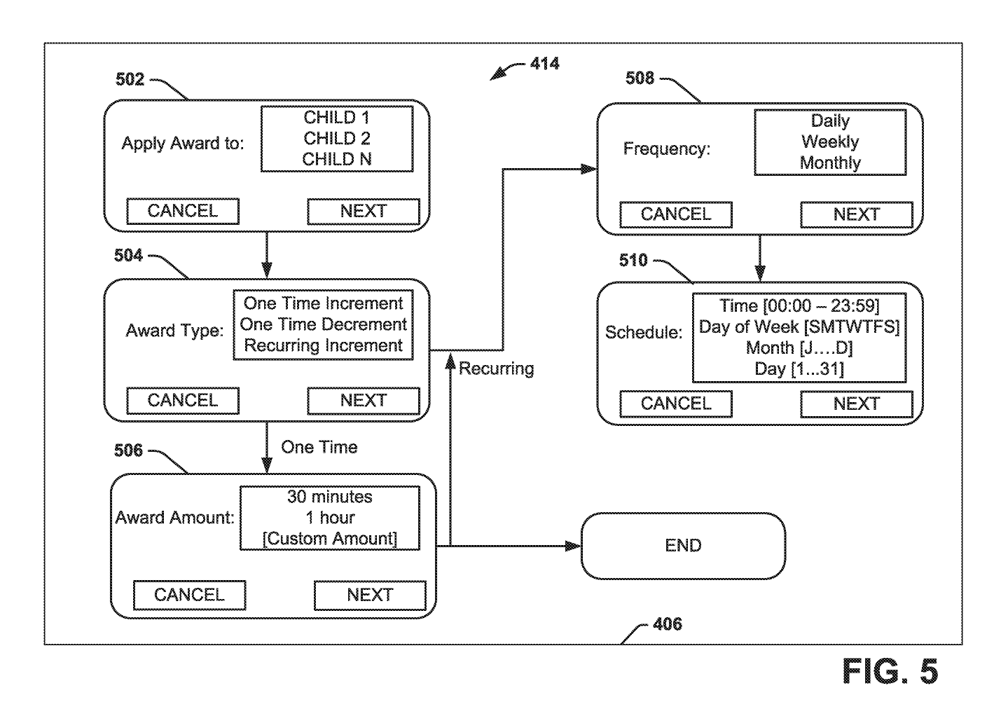

The master user profile 412 can generate a login sequence 416 via the gateway device 104, for example. One or more authentication factors 416 (e.g., an ID, a password, email, text, code confirmation/verification) can be generated to verity access to components of the gateway device 104 such as in relation to monitoring, restricting, blocking, setting, controlling, award processes and other components associated with one or more user profiles 410 or one or more groups of user devices 120 or 122. The user interface 400 can be accessed and modified as desired by a parent to enable controlling the usage or screen time of user devices within a wireless home network. Accessing the gateway device 104 via the master user profile 412 can enable a master user to operate or configure any of the components discussed herein, provide settings or parameters to the user devices 120 or 122, and configure award processes 414 in response to being accessed. These award processes 414 are described in greater detail with reference to FIG. 5 below.

One or more user profile(s) 410 can be generated as a result of successfully accessing the master user profile via a log-in, for example, or in response to activation of the award process(es) 414 (e.g., via a user interface control or button) associated with a particular user device 120, a group of multiple user devices 120, or a particular user. In response to a particular user profile 408 (e.g., per name, device id or otherwise) being selected, the interface controls can be generated or rendered for enabling parameters or criteria related to user device powering, media content streaming, or usage time as it relates to any one, or all of the user devices 120 associated with the particular user profile 408. Thus, as one user device (e.g., user device 120) uses an amount of time toward a total usage or operational time that is configured via the master user profile 412, the amount of set time can also decrease from the time allotted or permitted for all user devices associated with the same user profile 408 via the award processes 414.

In one example, groups of user devices (e.g., 120) can share settings or restrictions toward media content and operation, while users can also share the same user devices without any one user taking away from another user's time or held to the same restriction. Different users can then utilize their own time toward any one user device as well by their user profile 408. For example, each user profile can be designated to correspond to any one user device 120, 122, which could be shared among other user profiles or be designated to correspond as solely to one or more particular devices. Thus, if one user operates the user device 120 for a certain amount of time, this time is not taken away from another user because each user device would operate under the auspices of a particular profile. The time allotted or awarded for another user profile via the master user profile 412 could be unchanged by any changing of settings or restrictions among other user devices.

Alternatively or additionally, the master user profile 412 can provide restrictions or settings of parameters via the components discussed herein at the gateway device 104 without accessing a user profile 410 related to a particular device or user. For example, the user device(s) 120 can be blocked from one or more media content sources, websites, subscription of media content, or other source via the blocking component 308 of FIG. 3. In particular, these blocking operations can be enabled directly to a particular user device, such as with an associated user device identification or address unique to the user device and without utilizing any associated user profile 410. Any setting, parameter or restriction can be communicated to the user devices 120, for example, using the device identification and initiated/triggered at each user device directly. As a result, each user device or set of user devices 120 would have award processes applied to it via incrementing or decrementing time or usage according to the device itself and not any one particular user.

Whether connected to the gateway device 104 or not, time settings or other parameters being set for an amount of time, as well as online time frame with or without media content streaming (e.g., internet surfing, downloading, uploading, browsing or the like) can be shared from among user devices, as discussed above, set for any one particular user device, or separated with different user profiles 408 corresponding to one or more different settings, differing restrictions to content or operation, or vary among parameters, for example.

Referring now to FIG. 5, illustrated is an example user interface 500 with an input viewing screen 502 including the award processes 414 in accordance with various aspects described. The award processes 414 can be accessed and controlled via the master user profile 412 of FIG. 4. In response to receiving access to the master user profile 412, the award processes 414 can be managed and implemented to increment or decrement a setting or parameter related to the user device controls or components restricting or monitoring user devices 120 or 122.

A master user, for example, can enter the award processes 414 via the user interface of the gateway device 104. At 502, an award process or particular award (e.g., an increment in time based on an application or task achievement) can be allocated or assigned to particular child or user profile (e.g., Child 1, Child 2, Child N or the other user). Each “Child” N can correspond to a particular user profile 410 that is secured and associated to a particular user, or to a particular set of user devices 120 or 122, which could be owned or operated by a particular user within the home network.

At 504, an award type can be assigned as being a manual entry in response to the master user's request or a communication/indication received via the master user profile 412. For example, a “One Time Increment”, a “One Time Decrement”, or a “Recurring Increment” could be provided to a particular user device(s) 120 or user profile 410. Other options could also be generated for managing the award processes 414, such as recurring decrements, as well as responses to which the award type is provided other than a manual entry, such as the completion of a task, an application, adherence to a time within a schedule time or set time frame, or other such response, which can be a trigger communicated via a user device 120 or other device to the gateway device 104, for example.

In addition or alternatively, the one-time increment or decrement can be set as triggers to be added to a set time frame, duration or range of usage time for streaming media content, online access via the gateway device, operational powering of user device(s) 120 or 122, or other setting/parameter of one or more components. The increments or decrements, either one time or recurring, can be based on an application or task being communicated as having been achieved via the user device 120 or 122.

If the award type selected is one time, or provided at only once per entry via the master user profile 412 or communication of an achievement via the user device 120 or 122 associated with the user profile 410, then an award amount at 506 can be further selected as desired by which to increment a total time or set time frame, duration, or otherwise, in response to a manual entry or communication trigger received at the gateway device 104, for example. If the award type is to be recurring, then the frequency for replenishing a set time frame or amount of time can be allocated to the user device 120 or user profile 410, for example.

At 510, a certain schedule for replenishing or monitoring the particular frequency or the award type associated with the user device or profile can further be set. This operation can be controlled by the scheduling component 306 of FIG. 3, as described above, and further utilized to award or decrement settings such as operational time toward any user profile 410 or user device(s) 120, 122 within certain time frames (e.g., clocked times, days of the week, month, calendar day, or like settings).

In one example, a user (e.g., Child 1) can thus be selected via the master user profile 412, a recurring decrement can be selected, an amount of the decrement selected, as well as a frequency or a schedule providing additional constrains to the award process 414. The award process 414 can the implemented at ending and set conditions, settings or parameters discussed herein on the user devices 120 or 122, as a group, individually or according to associated user profiles, for example.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

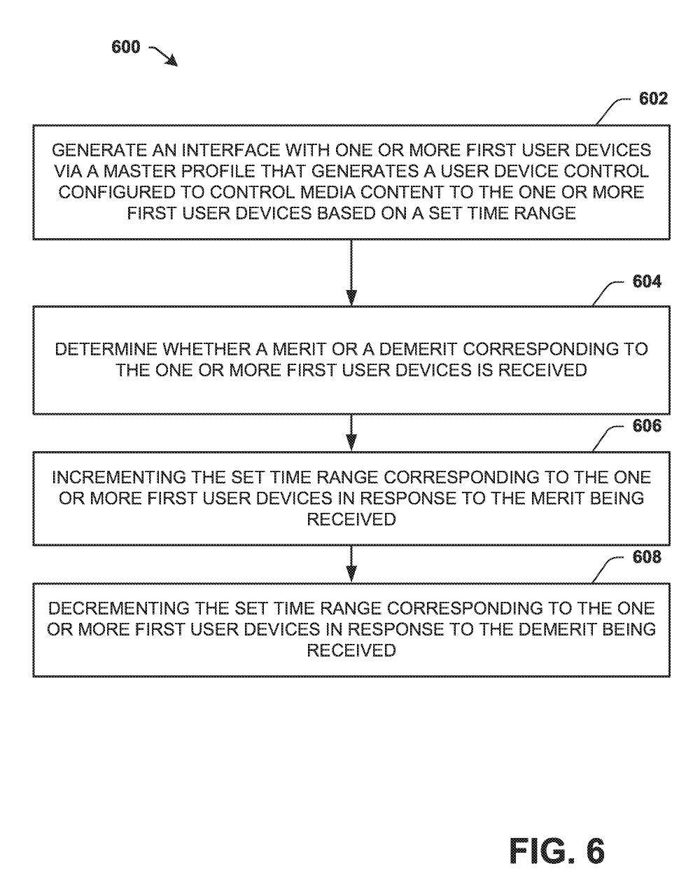

Referring to FIG. 6, illustrated is a method 600 employed in a gateway device of wireless network such as a home wireless network with a router, an access point, or other network device to manage a network and one or more user devices or groups of user devices (e.g., user devices 120 and 122). The method 600 can initiate at 602 with generating, via one or more processors, an interface with one or more first user devices (e.g., 120) via a master user profile (e.g., 310) that generates a user device control configured to control media content to the one or more first user devices based on a set time range.

At 604, the method further comprises determining whether a merit or a demerit corresponding to the one or more first user devices is received (e.g., at the gateway device 104 or award component 128).

At 606, the method further comprises incrementing the set time range corresponding to the one or more first user devices in response to the merit being received.

At 608, the method further comprises decrementing the set time range corresponding to the one or more first user devices in response to the demerit being received.

The method can further include blocking the media content to the one or more first user devices in response to the set time range being satisfied by a user device of a plurality of user devices or by an accumulated time from a plurality of user devices.

The merit or demerit can be set based on an amount to decrement or increment based on a task/application being completed, adherence to a schedule via the scheduling component 306, or by a manual entry via a master user profile of the user profiles 310. The merit or demerit can be received by the gateway device 104 from the one or more first user devices, the master profile, or both the one or more first user devices and the master profile, in which a communication of merit/demerit can come from the user device 120 or manually entered by a user (e.g., a parent) via a master profile.

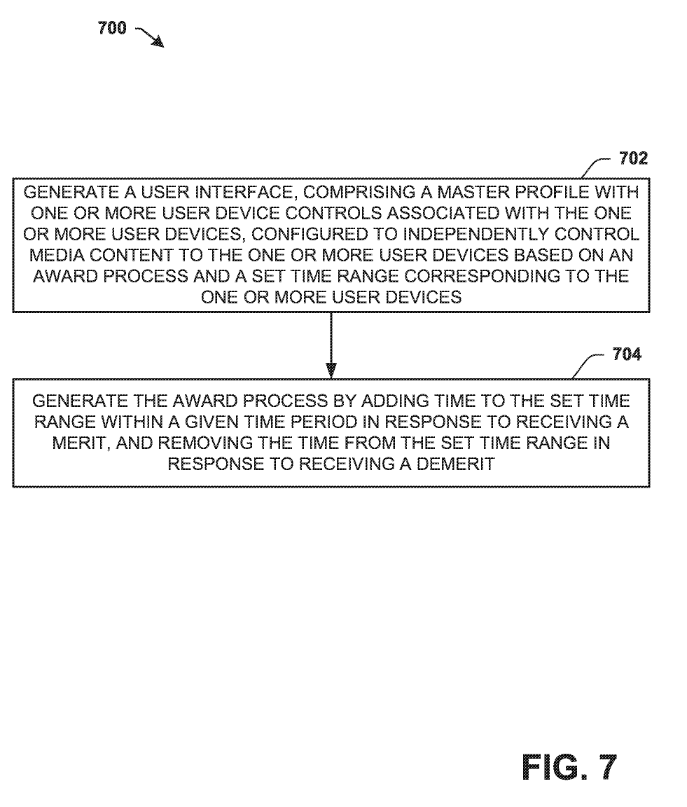

Referring to FIG. 7, illustrated is another example method 700 for an apparatus employed within a gateway device that can control one or more user devices within a wireless network (e.g., a home wireless network). The method initiates at 702 with generating a user interface comprising a master profile with one or more user device controls associated with the one or more user devices, configured to independently control media content to the one or more user devices based on an award process and a set time range corresponding to the one or more user devices.

At 704, the method comprises generating the award process by adding time to the set time range within a given time period in response to receiving a merit, and removing the time from the set time range in response to receiving a demerit.

One or more processors can further operate to block the one or more user devices from the media content or from being powered on, in response to at least one of: the set time range being satisfied within the given time period by the one or more user devices, a rating of the media content, a type of media content, a user device designation, a source of the media content, or a number of merits falling below a threshold within the given time period.

The method 700 can further include generating a duration control of the one or more user device controls that modifies a duration setting via the master profile, generates a first duration corresponding to one or more first user devices, and generates a second duration corresponding to one or more second user devices.

In one embodiment, a set schedule of media content can be further generated in a user profile that is associated with the one or more first user devices (e.g., 120) and the one or more second user devices (e.g., 122), wherein the set schedule of media content can include one or more a of: the set time range, a set time, the given time period associated with the set time range, or a media content source, by which the one or more first user devices and the one or more second user devices are configured to share in combination to receive the media content or be powered to operate.

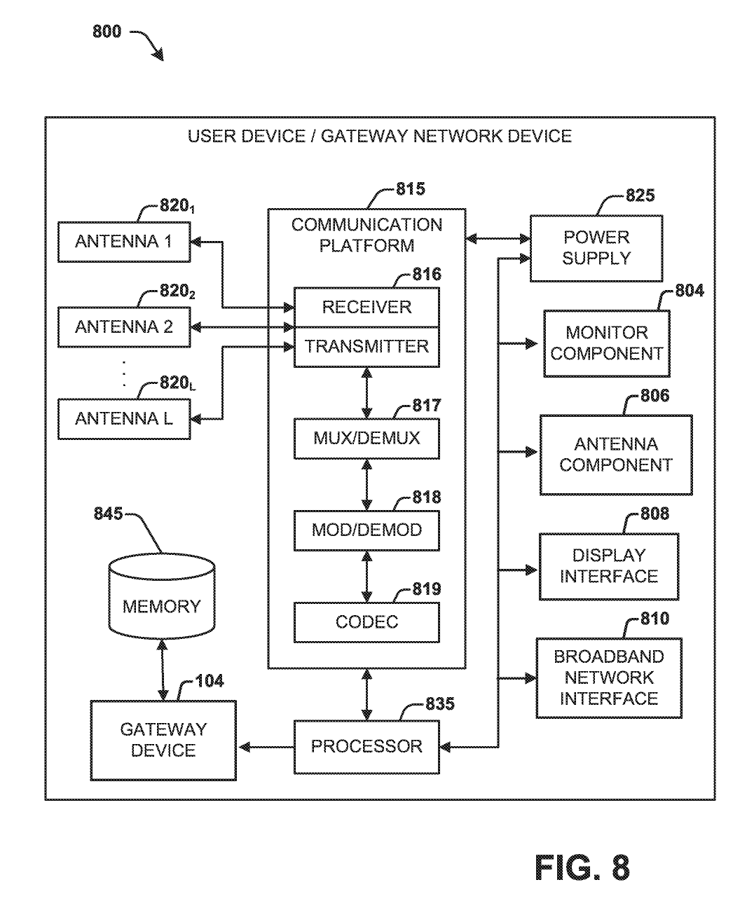

In order to provide further context for various aspects of the disclosed subject matter, FIG. 8 illustrates a non-limiting example of a computing device, such as a laptop, tablet, user equipment (e.g., mobile phone), user device, gateway network device (e.g., a device communicatively coupled to a home network with gateway device 104) or other communication device or wireless terminal 800 that can implement some or all of the aspects described herein. In an aspect, wireless terminal, such as a laptop, tablet, other communication device, or wireless terminal 800 can receive and transmit signal(s) to and/or from wireless devices such as APs, access terminals, wireless ports and routers, or the like, through a set of L antennas 820, which can be configured according to one or more embodiments or aspects described herein. In one example, antennas 820 can be implemented as part of a communication platform 815, which in turn can comprise electronic components and associated circuitry and/or other means that provide for processing and manipulation of received signal(s) and signal(s) to be transmitted. The antennas 820 can comprise the various antenna elements incorporating the different aspects or embodiments disclosed herein. In one example, the antennas 820 can be located along an edge or side 820 of the wireless terminal 800, which can be within a same quadrant, section, portion or subset of the volume of the mobile device, opposing or different sections, for example.

In an aspect, communication platform 815 can include a monitor component 804 and antenna component 806, which can couple to communication platform 815 and include electronic components with associated circuitry that provide for processing and manipulation of received signal(s) and other signal(s) to be transmitted. The communication platform 815 can further comprise a receiver/transmitter or transceiver 816, which can transmit and receive signals and/or perform one or more processing operations on such signals (e.g., conversion from analog to digital upon reception, conversion from digital to analog upon transmission, etc.). In addition, transceiver 816 can divide a single data stream into multiple, parallel data streams, or perform the reciprocal operation.

Additionally, the communication device 800 can include display interface 808, which can display functions that control functionality of the device 800, or reveal operation conditions thereof. In addition, display interface 808 can include a screen to convey information to an end user. In an aspect, display interface 808 can be a liquid crystal display, a plasma panel, a monolithic thin-film based electro chromic display, and so on. Moreover, display interface 808 can include a component (e.g., speaker) that facilitates communication of aural indicia, which can also be employed in connection with messages that convey operational instructions to an end user. Display interface 808 can also facilitate data entry (e.g., through a linked keypad or through touch gestures), which can cause access equipment and/or software 800 to receive external commands (e.g., restart operation).

Broadband network interface 820 facilitates connection of access equipment and/or software 800 to a service provider network (not shown) that can include one or more cellular technologies (e.g., third generation partnership project universal mobile telecommunication system, global system for mobile communication, and so on) through backhaul link(s) (not shown), which enable incoming and outgoing data flow. Broadband network interface 810 can be internal or external to access equipment and/or software 800, and can utilize display interface 808 for end-user interaction and status information delivery.

Processor 835 can be functionally connected to communication platform 808 and can facilitate operations on data (e.g., symbols, bits, or chips) for multiplexing/de-multiplexing, such as effecting direct and inverse fast Fourier transforms, selection of modulation rates, selection of data packet formats, inter-packet times, and so on. Moreover, processor 835 can be functionally connected, through data, system, or an address bus, to display interface 808 and broadband network interface 810, to confer, at least in part, functionality to each of such components.

In another example, a multiplexer/de-multiplexer (mux/demux) unit 817 can be coupled to transceiver 816. Mux/demux unit 817 can, for example, facilitate manipulation of signal in time and frequency space. Additionally or alternatively, mux/demux unit 817 can multiplex information (e.g., data/traffic, control/signaling, etc.) according to various multiplexing schemes such as time division multiplexing (TDM), frequency division multiplexing (FDM), orthogonal frequency division multiplexing (OFDM), code division multiplexing (CDM), space division multiplexing (SDM), or the like. In addition, mux/demux unit 817 can scramble and spread information according to substantially any code generally known in the art, such as Hadamard-Walsh codes, Baker codes, Kasami codes, polyphase codes, and so on.

In a further example, a modulator/demodulator (mod/demod) unit 818 implemented within communication platform 815 can modulate information according to multiple modulation techniques, such as frequency modulation, amplitude modulation (e.g., L-ary quadrature amplitude modulation (L-QAM), etc.), phase-shift keying (PSK), and the like. Further, communication platform 815 can also include a coder/decoder (codec) module 819 that facilitates decoding received signal(s) and/or coding signal(s) to convey.

According to another aspect, wireless terminal 800 can include a processor 835 configured to confer functionality, at least in part, to substantially any electronic component utilized by wireless terminal 800. As further shown in system 800, a power supply 825 can attach to a power grid and include one or more transformers to achieve a power level at which various components and/or circuitry associated with wireless terminal 800 can operate. In one example, power supply 825 can include a rechargeable power mechanism to facilitate continued operation of wireless terminal 800 in the event that wireless terminal 800 is disconnected from the power grid, the power grid is not operating, etc. The antennas, for example, with the other antenna element configurations can further facilitate communications with a wireless charging of the power supply 825, such as with a transfer of energy from the antenna system to the power supply 825 via an oscillating magnetic field, for example.

In a further aspect, processor 835 can be functionally connected to communication platform 815 and can facilitate various operations on data (e.g., symbols, bits, chips, etc.), which can include, but are not limited to, effecting direct and inverse fast Fourier transforms, selection of modulation rates, selection of data packet formats, inter-packet times, etc. In another example, processor 835 can be functionally connected, via a data or system bus (e.g., a wireless PCIE or the like), to any other components or circuitry not shown in system 800 to at least partially confer functionality to each of such components, such as by the antenna systems disclosed herein.

As additionally illustrated, a memory 845 can be used by wireless terminal 800 to store data structures, code instructions and program modules, system or device information, code sequences for scrambling, spreading and pilot transmission, location intelligence storage, determined delay offset(s), over-the-air propagation models, and so on. Processor 835 can be coupled to the memory 845 in order to store and retrieve information necessary to operate and/or confer functionality to communication platform 815 and/or any other components of wireless terminal 800.

Further, the antenna systems described above with the communication device 800 can also be configured, for example, to operate at a wide range of frequencies in a high band frequency range additionally include peer-to-peer (e.g., mobile-to-mobile) ad hoc network systems often using unpaired unlicensed spectrums, 802.xx wireless LAN, BLUETOOTH and any other short- or long-range, wireless frequency ranges and communication techniques. The narrow band antenna elements disclosed herein, such as antennas resonating systems of devices disclosed, for example, can also be configured to operate at other frequency ranges also.

In other examples, the components disclosed in other figures can operate to communicate wirelessly with other components, such as the display interface 808 as a wireless device, or with other wireless interfaces, such as a wireless USB device, for example. For example, a wireless USB device can communicate within a 3.1 to a 6.6 GHz frequency range. In addition, the antenna systems disclosed can be configured to communicate with other wireless connections, components, interfaces or devices in order to provide communication interfacing for wireless component-to-component communications. For example, a PCB to PCB interface can be facilitated by the high band antenna systems as well as micro millimeter wave communications among one or more internal or external components. Other communication interfaces can also be facilitated by the antenna elements disclosed such as an internet of things (IoT) to IoT components, wearable components, mobile to mobile, a network base station (e.g., a macro cell network device, femto cell device, pico cell device or other network devices) or any combination thereof to communicate via one of more of the antenna elements, such as via the antenna system or devices herein, for example. Additional other examples are also envisioned by which the antenna systems disclosed herein can operate in different frequency ranges, as well as communication and facilitate communications with, or among, one or more wireless components or devices. For example, industrial, scientific and medical (ISM) radio bands, radar band widths, or other ranges of a frequency spectrum can also be facilitated for communications by the antenna systems being disclosed.

Examples may include subject matter such as a method, means for performing acts or blocks of the method, at least one machine-readable medium including instructions that, when performed by a machine cause the machine to perform acts of the method or of an apparatus or system for concurrent communication using multiple communication technologies according to embodiments and examples described herein.

Example 1 is a system employed within a gateway device configured to control a plurality of user devices communicatively coupled to the gateway device in a home wireless network, the system comprising: a control component configured to generate a user interface with a master profile comprising one or more user device controls configured to control media content streaming to the plurality of user devices based on an award process and a set time range; and an award component configured to generate the award process by determining whether a merit or a demerit corresponding to at least one user device of the plurality of user devices is received, adding time to the set time range corresponding to the plurality of user devices in response to the merit being received, and removing the time from the set time range corresponding to the plurality of user devices in response to the demerit being received.

Example 2 includes the subject matter of Example 1, including or omitting any elements, wherein the award component is further configured to receive the merit from the at least one user device based on a successful completion of an application indicated by the at least one user device, and receive the demerit based on an amount of time that the media content streams to the at least one user device of the plurality of user devices or an amount of operation time that the at least one user device of the plurality of user devices is powered.

Example 3 includes the subject matter of any of Examples 1-2, including or omitting any elements, wherein the award component is further configured to receive the merit or the demerit from a manual setting of the one or more user device controls of the master profile.

Example 4 includes the subject matter of any of Examples 1-3, including or omitting any elements, wherein the control component is further configured to independently control a duration setting that controls the set time range corresponding to the media content streaming to the at least one user device of the plurality of user devices that is different from another set time range corresponding to another user device of the plurality of user devices.

Example 5 includes the subject matter of any of Examples 1-4, including or omitting any elements, wherein the control component is further configured to independently control a duration of operation of the plurality of user devices based on a number of merits and demerits corresponding to the at least one user device of the plurality of user devices.

Example 6 includes the subject matter of any of Examples 1-5, including or omitting any elements, wherein the award component is further configured to increment or decrement the time to the set time range based on a given time period set by the master profile associated with the plurality of user devices, and increment or decrement the time to another set time range for the given time period associated with another plurality of user devices.

Example 7 includes the subject matter of any of Examples 1-6, including or omitting any elements, further comprising: a scheduling component configured to generate a set schedule of media content in a user profile associated with the at least one user device of the plurality of user devices that comprises at least one of: the set time range, a set time, a time period associated with the set time range, a powering on time, or a media content source, by which the at least one user device of the plurality of user devices receives the media content or is powered to operate.

Example 8 includes the subject matter of any of Examples 1-7, including or omitting any elements, further comprising: a blocking component configured to block the at least one user device of the plurality of user devices from the media content based on the one or more user device controls of the master profile comprising at least one of the set time range, a time period, a rating of the media content streaming, a type of media content, a user device designation, a source of the media content or a number of merits and demerits.

Example 9 includes the subject matter of any of Examples 1-8, including or omitting any elements, wherein the control component is further configured to generate a duration control based on a duration setting of the master profile that generates a first duration corresponding to one or more first user devices of the plurality of user devices and a second duration corresponding to one or more second user devices of the plurality of user devices, wherein the first duration is different than the second duration.

Example 10 includes the subject matter of any of Examples 1-9, including or omitting any elements, wherein the control component is further configured to operate the duration control to restrict the media content streaming to the one or more first user devices and the one or more second user devices according to the first duration or the second duration, respectively, based on the duration control.

Example 11 includes the subject matter of any of Examples 1-10, including or omitting any elements, wherein the control component is further configured to determine the set time range that is assigned to the plurality of user devices from the master profile, accumulating an amount of operating time from among the plurality of user devices or from among user profiles assigned to the plurality of user devices, and block the media content from streaming to the plurality of user devices in response to the amount of operating time exceeding the set time range within a given time period by an accumulation of operating time from the plurality of user devices.

Example 12 is an apparatus employed within a gateway device that is configured to control one or more user devices within a wireless network comprising: one or more processors communicatively coupled to a memory configured to: generate a user interface comprising a master profile with one or more user device controls associated with the one or more user devices, configured to independently control media content to the one or more user devices based on an award process and a set time range corresponding to the one or more user devices; and generate the award process by adding time to the set time range within a given time period in response to receiving a merit, and removing the time from the set time range in response to receiving a demerit.

Example 13 includes the subject matter of Example 12, including or omitting any elements, wherein the merit comprises an increment of time in response to a communication of the one or more user devices indicating a completion of an application, or a manual setting provided via the one or more user device controls of the master profile, and wherein the demerit comprises a decrement in the time in response to at least one of: a use amount of the one or more user devices, a media content amount streamed to the one or more user devices, or the manual setting provided via the one or more user device controls of the master profile.

Example 14 includes the subject matter of any of Examples 12-13, including or omitting any elements, wherein the one or more processors are further configured to: block the one or more user devices from the media content or from being powered on, in response to at least one of: the set time range being satisfied within the given time period by the one or more user devices, a rating of the media content, a type of media content, a user device designation, a source of the media content, or a number of merits falling below a threshold within the given time period.

Example 15 includes the subject matter of any of Examples 12-14, including or omitting any elements, wherein the one or more processors are further configured to: generate a duration control of the one or more user device controls that modifies a duration setting via the master profile, generates a first duration corresponding to one or more first user devices, and generates a second duration corresponding to one or more second user devices.

Example 16 includes the subject matter of any of Examples 12-15, including or omitting any elements, wherein the one or more processors are further configured to: block the media content from streaming to the one or more first user devices in response to the first duration being satisfied by any one of the one or more first user devices.

Example 17 includes the subject matter of any of Examples 12-16, including or omitting any elements, wherein the one or more processors are further configured to: generate a set schedule of media content in a user profile associated with the one or more first user devices and the one or more second user devices, wherein the set schedule of media content comprises at least one of: the set time range, a set time, the given time period associated with the set time range, or a media content source, by which the one or more first user devices and the one or more second user devices are configured to share in combination to receive the media content or be powered to operate.

Example 18 is a method for a gateway device comprising: generating, via one or more processors, an interface with one or more first user devices via a master profile that generates a user device control configured to control media content to the one or more first user devices based on a set time range; and determining whether a merit or a demerit corresponding to the one or more first user devices is received; incrementing the set time range corresponding to the one or more first user devices in response to the merit being received; and decrementing the set time range corresponding to the one or more first user devices in response to the demerit being received.

Example 19 includes the subject matter of Example 18, including or omitting any elements, further comprising: blocking the media content to the one or more first user devices in response to the set time range being satisfied by a user device of the one or more first user devices or by an accumulated time from a plurality of user devices of the one or more first user devices.

Example 20 includes the subject matter of any of Examples 18-19, including or omitting any elements, further comprising: receiving the merit from the one or more first user devices, the master profile, or both the one or more first user devices and the master profile; and receiving the demerit from the one or more first user devices, the master profile or both, based on an amount of time that the media content streams to the one or more first user devices or an amount of operation time corresponding to the one or more first user devices.

Example 21 includes the subject matter of any of Examples 18-20, including or omitting any elements, further comprising: powering off the one or more first user devices in response to an amount of operational time satisfying the set time range.

Example 22 includes the subject matter of any of Examples 18-21, including or omitting any elements, further comprising: determining whether the merit or the demerit corresponds to a first user profile or a second user profile corresponding to the one or more first user devices, and independently controlling a duration setting that sets the set time range corresponding to the first user profile differently than the second user profile based on a number of merits and demerits corresponding to the first user profile and the second user profile.

Example 23 includes the subject matter of any of Examples 18-22, including or omitting any elements, further comprising: accumulating a media content amount by the one or more first user devices and one or more second user devices; and blocking the media content from streaming to the one or more first user devices and the one or more second user devices in response to a media content threshold being exceeded by the media content amount.

Example 24 includes the subject matter of any of Examples 18-23, including or omitting any elements, further comprising: accumulating usage time by the one or more first user devices and one or more second user devices communicatively coupled to the gateway device; and blocking the media content from streaming to the one or more first user devices and the one or more second user devices in response to the set time range being exceeded by the usage time.

Example 25 is a computer-readable medium storing executable instructions that, in response to execution, cause one or more processors of a gateway device to perform operations, comprising: generating an interface with a plurality of user devices via a master profile that generates a user device control configured to control media content to the plurality of user devices based on a set time range; determining whether a merit or a demerit corresponding to the plurality of user devices is received; incrementing the set time range corresponding to the plurality of user devices in response to the merit being received; and decrementing the set time range corresponding to the plurality of user devices in response to the demerit being received.

Example 26 includes the subject matter of Examples 25, including or omitting any elements, further comprising: blocking the media content to the plurality of user devices in response to the set time range being satisfied by a user device of the plurality of user devices or by an accumulated time from a plurality of user devices of the plurality of user devices.

Example 27 includes the subject matter of any of Examples 25-26, including or omitting any elements, further comprising: receiving the merit from at least one of: the plurality of user devices or the master profile; and receiving the demerit from at least one of the plurality of user devices or the master profile, based on an amount of time that the media content streams to the plurality of user devices or an amount of operation time corresponding to the plurality of user devices.

Example 28 includes the subject matter of any of Examples 25-27, including or omitting any elements, further comprising: powering off or blocking powering of the plurality of user devices in response to an amount of operational time satisfying the set time range.

Example 29 includes the subject matter of any of Examples 25-28, including or omitting any elements, further comprising: determining whether the merit or the demerit corresponds to a first user profile or a second user profile corresponding to the plurality of user devices, and independently controlling a duration setting that sets the set time range corresponding to the first user profile differently than the second user profile based on a number of merits and demerits corresponding to the first user profile and the second user profile.

Example 30 includes the subject matter of any of Examples 25-29, including or omitting any elements, further comprising: accumulating a media content amount by the plurality of user devices and one or more second user devices; and blocking the media content from streaming to the plurality of user devices and the one or more second user devices in response to a media content threshold being exceeded by the media content amount.

Example 31 includes the subject matter of any of Examples 25-30, including or omitting any elements, further comprising: accumulating usage time by the plurality of user devices and one or more other user devices communicatively coupled to the gateway device; and blocking the media content from streaming to the plurality of user devices and the one or more other user devices in response to the set time range being exceeded.

Example 32 is an apparatus employed within a gateway device that is configured to control one or more user devices within a wireless network comprising: means for generating an interface with a plurality of user devices via a master profile that generates a user device control configured to control media content to the plurality of user devices based on a set time range; means for determining whether a merit or a demerit corresponding to the plurality of user devices is received; means for incrementing the set time range corresponding to the plurality of user devices in response to the merit being received; and means for decrementing the set time range corresponding to the plurality of user devices in response to the demerit being received.

Example 33 includes the subject matter of Example 32, including or omitting any elements, further comprising: means for blocking the media content to the plurality of user devices in response to the set time range being satisfied by a user device of the plurality of user devices or by an accumulated time from a plurality of user devices of the plurality of user devices.

Example 34 includes the subject matter of any of Examples 32-33, including or omitting any elements, further comprising: means for receiving the merit from at least one of: the plurality of user devices or the master profile; and means for receiving the demerit from at least one of the plurality of user devices or the master profile, based on an amount of time that the media content streams to the plurality of user devices or an amount of operation time corresponding to the plurality of user devices.

Example 35 includes the subject matter of any of Examples 32-34, including or omitting any elements, further comprising: means for powering off or blocking powering of the plurality of user devices in response to an amount of operational time satisfying the set time range.

Example 36 includes the subject matter of any of Examples 32-35, including or omitting any elements, further comprising: means for determining whether the merit or the demerit corresponds to a first user profile or a second user profile corresponding to the plurality of user devices, and independently controlling a duration setting that sets the set time range corresponding to the first user profile differently than the second user profile based on a number of merits and demerits corresponding to the first user profile and the second user profile.

Example 37 includes the subject matter of any of Examples 32-36, including or omitting any elements, further comprising: means for accumulating a media content amount by the plurality of user devices and one or more second user devices; and means for blocking the media content from streaming to the plurality of user devices and the one or more second user devices in response to a media content threshold being exceeded by the media content amount.

Example 38 includes the subject matter of any of Examples 18-26, including or omitting any elements, further comprising: means for accumulating usage time by the plurality of user devices and one or more other user devices communicatively coupled to the gateway device; and means for blocking the media content from streaming to the plurality of user devices and the one or more other user devices in response to the set time range being exceeded.

Applications (e.g., program modules) can include routines, programs, components, data structures, etc., that perform particular tasks or implement particular abstract data types. Moreover, those skilled in the art will appreciate that the operations disclosed can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated mobile or personal computing devices.

A computing device can typically include a variety of computer-readable media. Computer readable media can be any available media that can be accessed by the computer and includes both volatile and non-volatile media, removable and non-removable media. By way of example and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media (e.g., one or more data stores) can include, but is not limited to, RAM, ROM, EEPROM, flash memory or other memory technology, CD ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

It is to be understood that aspects described herein may be implemented by hardware, software, firmware, or any combination thereof. When implemented in software, functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if software is transmitted from a website, server, or other remote source using a coaxial cable, fiber optic cable, twisted pair, digital subscriber line (DSL), or wireless technologies such as infrared, radio, and microwave, then coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Various illustrative logics, logical blocks, modules, and circuits described in connection with aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor may be a microprocessor, but, in the alternative, processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration. Additionally, at least one processor may comprise one or more modules operable to perform one or more of the acts and/or actions described herein.

For a software implementation, techniques described herein may be implemented with modules (e.g., procedures, functions, and so on) that perform functions described herein. Software codes may be stored in memory units and executed by processors. Memory unit may be implemented within processor or external to processor, in which case memory unit can be communicatively coupled to processor through various means as is known in the art. Further, at least one processor may include one or more modules operable to perform functions described herein.

Techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. Further, CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on downlink and SC-FDMA on uplink. UTRA, E-UTRA, UMTS, LTE and GSM are described in documents from an organization named “3rd Generation Partnership Project” (3GPP). Additionally, CDMA2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques, such as millimeter wave bands in the range of 30 GHz to 300 GHz, for example.

Single carrier frequency division multiple access (SC-FDMA), which utilizes single carrier modulation and frequency domain equalization is a technique that can be utilized with the disclosed aspects. SC-FDMA has similar performance and essentially a similar overall complexity as those of OFDMA system. SC-FDMA signal has lower peak-to-average power ratio (PAPR) because of its inherent single carrier structure. SC-FDMA can be utilized in uplink communications where lower PAPR can benefit a mobile terminal in terms of transmit power efficiency.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical discs (e.g., compact disc (CD), digital versatile disc (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product may include a computer readable medium having one or more instructions or codes operable to cause a computer to perform functions described herein.

Further, the acts and/or actions of a method or algorithm described in connection with aspects disclosed herein may be embodied directly in hardware, in a software module executed by a processor, or a combination thereof. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to processor, such that processor can read information from, and write information to, storage medium. In the alternative, storage medium may be integral to processor. Further, in some aspects, processor and storage medium may reside in an ASIC. Additionally, ASIC may reside in a user terminal. In the alternative, processor and storage medium may reside as discrete components in a user terminal. Additionally, in some aspects, the acts and/or actions of a method or algorithm may reside as one or any combination or set of codes and/or instructions on a machine-readable medium and/or computer readable medium, which may be incorporated into a computer program product.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature may have been disclosed with respect to only one of several implementations, such feature may be combined with one or more other features of the other implementations as may be desired and advantageous for any given or particular application.

What is claimed is:

1. A system employed within a gateway device configured to control a plurality of user devices communicatively coupled to the gateway device in a home wireless network, the system comprising:
a control component configured to generate a user interface with a master profile comprising one or more user device controls configured to control media content streaming to the plurality of user devices based on an award process and a set time range; and
an award component configured to generate the award process by determining whether a merit or a demerit corresponding to at least one user device of the plurality of user devices is received, adding time to the set time range corresponding to the plurality of user devices in response to the merit being received, and removing the time from the set time range corresponding to the plurality of user devices in response to the demerit being received.

2. The system of claim 1, wherein the award component is further configured to receive the merit from the at least one user device based on a successful completion of an application indicated by the at least one user device, and receive the demerit based on an amount of time that the media content streams to the at least one user device of the plurality of user devices or an amount of operation time that the at least one user device of the plurality of user devices is powered.

3. The system of claim 1, wherein the award component is further configured to receive the merit or the demerit from a manual setting of the one or more user device controls of the master profile.

4. The system of claim 1, wherein the control component is further configured to independently control a duration setting that controls the set time range corresponding to the media content streaming to the at least one user device of the plurality of user devices that is different from another set time range corresponding to another user device of the plurality of user devices.

5. The system of claim 1, wherein the control component is further configured to independently control a duration of operation of the plurality of user devices based on a number of merits and demerits corresponding to the at least one user device of the plurality of user devices.

6. The system of claim 1, wherein the award component is further configured to increment or decrement the time to the set time range based on a given time period set by the master profile associated with the plurality of user devices, and increment or decrement the time to another set time range for the given time period associated with another plurality of user devices.

7. The system of claim 1, further comprising:
a scheduling component configured to generate a set schedule of media content in a user profile associated with the at least one user device of the plurality of user devices that comprises at least one of: the set time range, a set time, a time period associated with the set time range, a powering on time, or a media content source, by which the at least one user device of the plurality of user devices receives the media content or is powered to operate.

8. The system of claim 1, further comprising:
a blocking component configured to block the at least one user device of the plurality of user devices from the media content based on the one or more user device controls of the master profile comprising at least one of the set time range, a time period, a rating of the media content streaming, a type of media content, a user device designation, a source of the media content or a number of merits and demerits.

9. The system of claim 1, wherein the control component is further configured to generate a duration control based on a duration setting of the master profile that generates a first duration corresponding to one or more first user devices of the plurality of user devices and a second duration corresponding to one or more second user devices of the plurality of user devices, wherein the first duration is different than the second duration.

10. The system of claim 9, wherein the control component is further configured to operate the duration control to restrict the media content streaming to the one or more first user devices and the one or more second user devices according to the first duration or the second duration, respectively, based on the duration control.

11. The system of claim 1, wherein the control component is further configured to determine the set time range that is assigned to the plurality of user devices from the master profile, accumulating an amount of operating time from among the plurality of user devices or from among user profiles assigned to the plurality of user devices, and block the media content from streaming to the plurality of user devices in response to the amount of operating time exceeding the set time range within a given time period by an accumulation of operating time from the plurality of user devices.

12. An apparatus employed within a gateway device that is configured to control one or more user devices within a wireless network comprising:
one or more processors communicatively coupled to a memory configured to:
generate a user interface comprising a master profile with one or more user device controls associated with the one or more user devices, configured to independently control media content to the one or more user devices based on an award process and a set time range corresponding to the one or more user devices; and
generate the award process by adding time to the set time range within a given time period in response to receiving a merit, and removing the time from the set time range in response to receiving a demerit.

13. The apparatus of claim 12, wherein the merit comprises an increment of time in response to a communication of the one or more user devices indicating a completion of an application, or a manual setting provided via the one or more user device controls of the master profile, and wherein the demerit comprises a decrement in the time in response to at least one of: a use amount of the one or more user devices, a media content amount streamed to the one or more user devices, or the manual setting provided via the one or more user device controls of the master profile.

14. The apparatus of claim 12, wherein the one or more processors are further configured to:
block the one or more user devices from the media content or from being powered on, in response to at least one of: the set time range being satisfied within the given time period by the one or more user devices, a rating of the media content, a type of media content, a user device designation, a source of the media content, or a number of merits falling below a threshold within the given time period.

15. The apparatus of claim 12, wherein the one or more processors are further configured to:
generate a duration control of the one or more user device controls that modifies a duration setting via the master profile, generates a first duration corresponding to one or more first user devices, and generates a second duration corresponding to one or more second user devices.

16. The apparatus of claim 15, wherein the one or more processors are further configured to:
block the media content from streaming to the one or more first user devices in response to the first duration being satisfied by any one of the one or more first user devices.

17. The apparatus of claim 15, wherein the one or more processors are further configured to:
generate a set schedule of media content in a user profile associated with the one or more first user devices and the one or more second user devices, wherein the set schedule of media content comprises at least one of: the set time range, a set time, the given time period associated with the set time range, or a media content source, by which the one or more first user devices and the one or more second user devices are configured to share in combination to receive the media content or be powered to operate.

18. A method for a gateway device comprising:
generating, via one or more processors, an interface with one or more first user devices via a master profile that generates a user device control configured to control media content to the one or more first user devices based on a set time range;
determining whether a merit or a demerit corresponding to the one or more first user devices is received;
incrementing the set time range corresponding to the one or more first user devices in response to the merit being received; and
decrementing the set time range corresponding to the one or more first user devices in response to the demerit being received.

19. The method of claim 18, further comprising:
blocking the media content to the one or more first user devices in response to the set time range being satisfied by a user device of the one or more first user devices or by an accumulated time from a plurality of user devices of the one or more first user devices.

20. The method of claim 18, further comprising:
receiving the merit from the one or more first user devices, the master profile, or both the one or more first user devices and the master profile; and
receiving the demerit from the one or more first user devices, the master profile or both, based on an amount of time that the media content streams to the one or more first user devices or an amount of operation time corresponding to the one or more first user devices.

21. The method of claim 18, further comprising:
powering off the one or more first user devices in response to an amount of operational time satisfying the set time range.

22. The method of claim 18, further comprising:
determining whether the merit or the demerit corresponds to a first user profile or a second user profile corresponding to the one or more first user devices, and independently controlling a duration setting that sets the set time range corresponding to the first user profile differently than the second user profile based on a number of merits and demerits corresponding to the first user profile and the second user profile.

23. The method of claim 18, further comprising:
accumulating a media content amount by the one or more first user devices and one or more second user devices; and
blocking the media content from streaming to the one or more first user devices and the one or more second user devices in response to a media content threshold being exceeded by the media content amount.

24. The method of claim 18, further comprising:
accumulating usage time by the one or more first user devices and one or more second user devices communicatively coupled to the gateway device; and
blocking the media content from streaming to the one or more first user devices and the one or more second user devices in response to the set time range being exceeded by the usage time.
